(19) United States
(12) Patent Application Publication
(10) Pub. No.: US 2023/0232500 A1
(43) Pub. Date: Jul. 20, 2023

(54) NOVEL ELECTRIC HEATING COVERING DEVICE

(71) Applicant: Zhejiang Shuoqi Home Textiles Co., Ltd., Yuyao City (CN)

(72) Inventors: Tianming Luo, Xinshao County (CN); Mingwen Qi, Suzhou City (CN); Yibing XIA, Longshan County (CN); Genkun DENG, Guanyang County (CN)

(21) Appl. No.: 17/655,288

(22) Filed: Mar. 17, 2022

(30) Foreign Application Priority Data
Jan. 19, 2022 (CN) 202210062444.2

(51) Int. Cl. H05B 1/02; H05B 3/56; A47G 9/02

(52) U.S. Cl. CPC H05B 1/0272; A47G 9/0215; A47G 9/0223; H05B 3/56

(57) ABSTRACT

The present application relates to the technical field of household electric appliances, in particular to a novel electric heating covering device, which includes a main controller integrated in a male connector and configured to realize real-time temperature control; an auxiliary controller provided with a built-in control circuit with an MCU and configured to acquire user control information; an auxiliary control power supply and communication line configured to connect the main controller and the auxiliary controller, wherein the main controller supplies power to the auxiliary controller through the auxiliary control power supply and communication line to realize two-way communication; a heating body provided with a heating wire and configured to convert electric energy into heat energy. Therefore, the present application only needs one power line for connection with the mains supply, and completely realizes real-time temperature control.

### CROSS REFERENCE TO RELATED APPLICATIONS

This is a U. S. Pat. Application which claims the priority and benefit of Chinese Patent Application Number 202210062444.2, filed on Jan. 19, 2022, the disclosure of which is incorporated herein by reference in its entirety.

### TECHNICAL FIELD

The present application relates to the technical field of household electric appliances, in particular to a novel electric heating covering device.

### BACKGROUND

The technology of the existing electric heating tippet or electric heating covering blanket has been very mature in the original structure or control mode, and there is basically no possibility to improve the process or cost. There are no more than two paths for development. One is that a breakthrough can be made when heating materials are used in the blanket body, and the other is that the control mode or the overall structure of the product can make a breakthrough. The first path is not our company’s strong point. We can only work hard on product control mode or structural layout.

The existing electric heating tippet or electric heating covering blanket is externally attached with a control box with considerable volume. One end is connected to the mains supply through a power line, and the other end is connected to the blanket body through a long and heavy connecting line (usually three-core to six-core wire). In this way, when the blanket body covers the human body, it has to take a set of cumbersome control system (power line, control box, bulky connecting line), which not only brings users a very bad use experience, but also makes the product cost unable to be reduced, thus reducing the market competitiveness of the product.

### SUMMARY

Aiming at the defects of the prior art, the present application discloses a novel electric heating covering device to solve the above problem.

The present application is implemented by adopting the following technical solution:

The present application provides a novel electric heating covering device, which includes:
a main controller integrated in a male connector and configured to realize real-time temperature control, collect temperature control state information in real time, and transmit the temperature control state information to an auxiliary controller of a product through a data communication circuit;
the auxiliary controller provided with a built-in control circuit with an MCU and configured to acquire user control information, transmit the user control information to the main controller, and simultaneously display the temperature control state information transmitted from the main controller;
an auxiliary control power supply and communication line configured to connect the main controller and the auxiliary controller, the main controller supplying power to the auxiliary controller through the auxiliary control power supply and communication line to realize two-way communication;
a heating body provided with a heating wire and configured to convert electric energy into heat energy, a multilayer flexible fabric being closely sewn outside the heating wire.

Further, the male connector is provided with a built-in real-time temperature control main control circuit with an MCU.

Further, the real-time temperature control main control circuit with the MCU includes a low-voltage DC power supply circuit, an MCU main control circuit, a temperature control sampling circuit, a temperature control driving circuit, a temperature control protection circuit, a data communication circuit, and an information indication circuit.

Further, the main controller, the auxiliary controller and the heating wire are all connected with a female connector.

Further, the control circuit with the MCU includes a low-voltage DC conversion circuit, an MCU auxiliary control circuit, a data communication circuit, a control information acquisition circuit, and a state display circuit.

Further, the heating body includes a heating wire, which is uniformly and densely sewn in the middle of a non-woven fabric by a sewing thread.

Further, the main controller includes a main controller upper cover, a main controller lower cover, a connecting terminal welded on a main controller PCB, the main controller PCB, and a fixing screw or fastener.

Further, the novel electric heating covering device further includes a blanket body, and the blanket body consists of a connecting base fixed on the blanket body, an auxiliary control power supply communication line, an auxiliary controller configured to realize man-machine dialoguing, a heating wire configured to heat, and a two-layer or multilayer fabric configured to fix and cover the heating wire.

Further, the connecting base includes a connector fixing piece, a connector upper cover, a connecting line sheath configured to protect the heating wire, a connector PCB, a male terminal fixed on the connector PCB, and a connector lower cover.

The present application has the following beneficial effects:

The electric heating tippet or electric heating covering blanket provided by the present application realizes the miniaturization of the control circuit, and integrates the control circuit on the male connector connected with the blanket body. Therefore, the present application only needs one power line for connection with the mains supply, and completely realizes real-time temperature control. Thus, on the one hand, a set of cumbersome controller and blanket body connecting line externally attached to the existing electric tippet or electric blanket is omitted. On the other hand, the product cost is greatly reduced.

### DESCRIPTION OF THE DRAWINGS

In order to more clearly describe the embodiments of the present application or the technical solutions in the prior art, the following will briefly introduce the drawings needed to be used in the embodiments or the description of the prior art. It is obvious that the drawings in the following description are only some embodiments of the present application. Those skilled in the art may obtain other drawings according to these drawings without contributing any inventive labor.

FIG. 1 is a schematic diagram of a first mounting structure in the principle of an electric heating tippet or electric heating covering blanket according to an embodiment of the present application.

FIG. 2 is an exploded view of a first product in the principle of an electric heating tippet or electric heating covering blanket according to an embodiment of the present application.

FIG. 3 is a schematic diagram of a second mounting structure in the principle of an electric heating tippet or electric heating covering blanket according to an embodiment of the present application.

FIG. 4 is an exploded view of a second product in the principle of an electric heating tippet or electric heating covering blanket according to an embodiment of the present application.

### DESCRIPTION OF THE EMBODIMENTS

In order to make the purposes, technical solutions and advantages of the embodiments of the present application more clear, the technical solution in the embodiments of the present application will be clearly and completely described below with reference to the drawings in the embodiments of the present application. Obviously, the described embodiments are part of the embodiments of the present application, not all of the embodiments. Based on the embodiments of the present application, all other embodiments obtained by ordinary technicians in the art without contributing any inventive labor shall fall within the scope of protection of the present application.

### Embodiment 1

This embodiment provides a structural form of an electric heating tippet or electric heating covering blanket, which includes the follows:

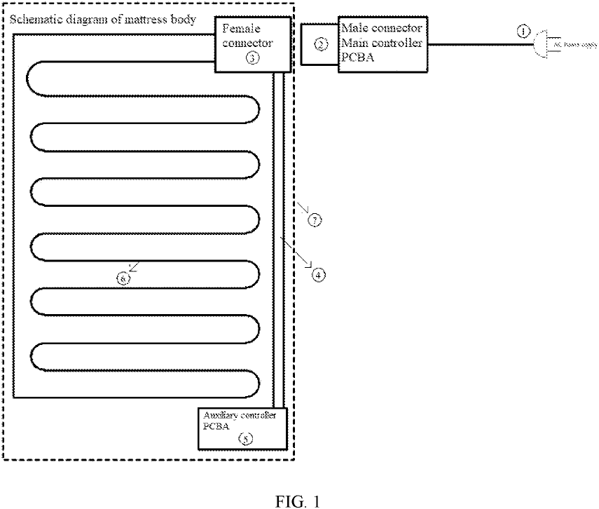

Power supply input: referring to FIG. 1, ① represents a mains supply plug, which is connected with a male connector (main controller) of a blanket body through a two-core or three-core power line to provide power for the whole system.

Main controller of product: referring to FIG. 1, ② represents a main controller of the product, which combines the functions of the male connector of the blanket body and the main controller. This is also the key point of the present application.

In this embodiment, the male connector is provided with a built-in real-time temperature control main control circuit with an MCU, which mainly consists of a low-voltage DC power supply circuit, an MCU main control circuit, a temperature control sampling circuit, a temperature control driving circuit, a temperature control protection circuit, a data communication circuit, an information indication circuit, etc. It is used to implement a complete real-time temperature control function, collect temperature control state information in real time, and transmit the temperature control state information to an auxiliary controller of the product through the data communication circuit. The auxiliary controller of the product displays the current temperature control state (including heating level information, timing information, fault information, etc.).

Female connector of blanket body: referring to FIG. 1, ③ represents a female connector of the blanket body, which mainly plays a role of connecting the main controller with the auxiliary controller and a heating wire.

Auxiliary control power supply and communication line: referring to FIG. 1, ④ represents an auxiliary control power supply and communication line, which mainly plays a role of connecting the main controller with the auxiliary controller. The main controller supplies power to the auxiliary controller through the auxiliary control power supply and communication line to realize two-way communication.

Auxiliary controller of product: referring to FIG. 1, ⑤ represents the auxiliary controller of the product, which is sewn by a silica gel panel at a position convenient for operation of the blanket body, is provided with a set of built-in control circuit with an MCU, and mainly includes a low-voltage DC conversion circuit, an MCU auxiliary control circuit, a data communication circuit, a control information acquisition circuit, and a state display circuit. The auxiliary controller is mainly responsible for acquiring user control information, transmitting the user control information to the main controller for use as temperature control data, and displaying the temperature control state information transmitted from the main controller.

Heating wire: referring to FIG. 1, ⑥ represents a heating wire of the product, which is mainly responsible for converting electric energy into heat energy so that the blanket body outputs heat to the outside.

Heating blanket body: referring to FIG. 1, ⑦ represents a body part of the product, which is formed by a multilayer flexible fabric closely sewn according to certain rules.

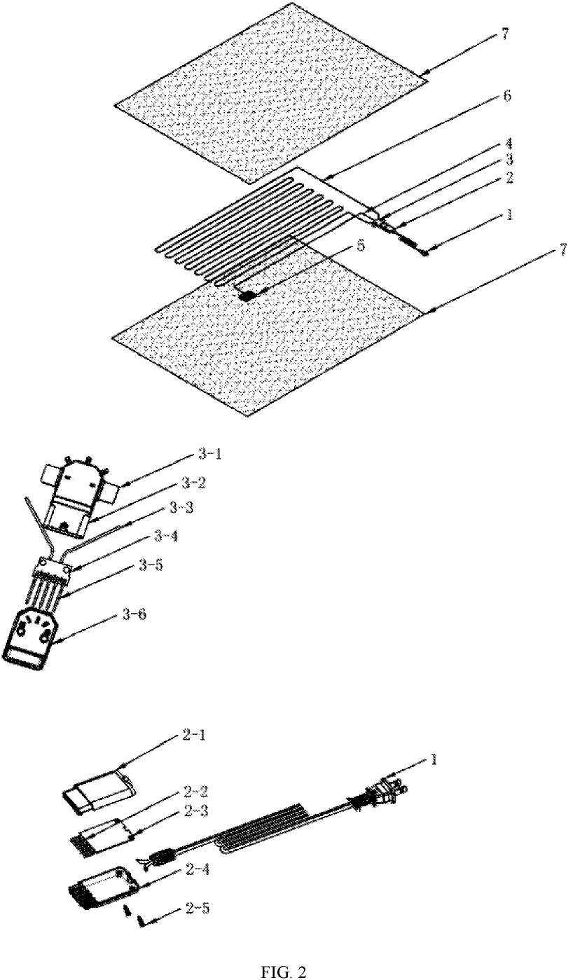

Referring to FIG. 2, in this embodiment, the product consists of a controller and a blanket body. The controller consists of a power line and a plug 1 for connecting the power grid. The power line is directly connected with the main controller 2.

In this embodiment, the main controller consists of a main controller upper cover 2-1, a main controller lower cover 2-4, a connecting terminal 2-2 welded on a main controller PCB, a main controller PCB 2-3, and fixing screws or fasteners 2-5. The blanket body consists of a connecting base 3 fixed on the blanket body, an auxiliary control power supply communication line 4, an auxiliary controller 5 configured to realize man-machine dialoguing (to input operation information and display the working state of the electric heating blanket), a heating wire 6 configured to heat, and a two-layer or multilayer fabric 7 configured to fix and cover the heating wire.

In this embodiment, the connecting base 3 includes a connector fixing piece 3-1 (soft plastic facilitating sewing the connecting base on the blanket body), a connector upper cover 3-2, a connecting line sheath 3-3 configured to protect the heating wire, a connector PCB 3-4, a male terminal 3-5 fixed on the connector PCB, and a connector lower cover 3-6.

In the specific implementation of this embodiment, the fabric 7 fixes the heating wire 6 according to a certain shape; the auxiliary controller 5 is fixed on the blanket body and connected with the PCB 3-4 in the female connector 3 of the blanket body fixed on the edge of the blanket body through a communication line.

In this embodiment, two ends of the heating wire 6 pass through the connecting line sheath 3-3 and are connected to the PCB 3-4 of the female connector 3 of the blanket body through a welding process; the male terminal 3-5 is welded on the PCB 3-4 and configured to realize electric connection with the female terminal of the main controller 2-2; the PCB 3-4 and the connector fixing piece 3-1 are clamped between the connector upper cover 3-2 and the connector lower cover 3-6, and then sewn on the blanket body through the connector fixing piece 3-1 to form the electric heating blanket body.

In this embodiment, the blanket body is connected to the main controller 2 through the female connector 3 of the blanket body, and the male terminal 3-5 completes the electrical connection with the female terminal 2-2; the female terminal 2-2 and the power line 1 are welded on the main controller PCB 2-3, and the main controller PCB 2-3 is fixed inside the controller upper cover 2-1 and the controller lower cover 2-4 through screws or pins 2-5.

The working mode of this embodiment is that the working state of the blanket body is set by operating the key on the auxiliary controller 5. The auxiliary controller 5 can also display the setting state and working state of the product in real time.

### Embodiment 2

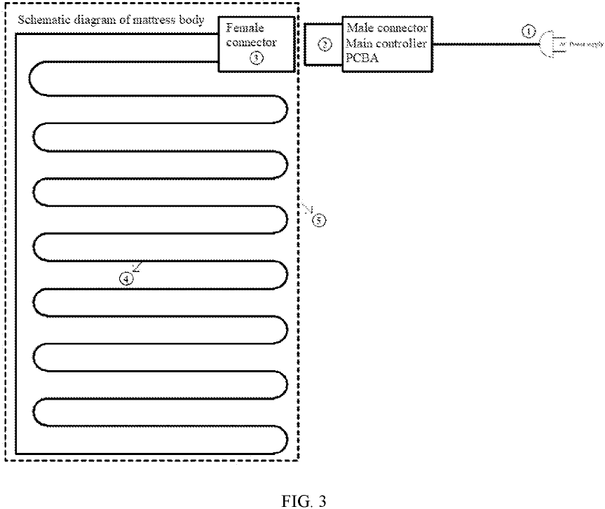

This embodiment provides another structural form of an electric heating tippet or electric heating covering blanket, which includes the follows: Power supply input: referring to FIG. 3, ① represents a mains supply plug, which is connected with a male connector (main controller) of a blanket body through a two-core or three-core power line to provide power for the whole system.

Main controller of product: referring to FIG. 3, ② represents a main controller of the product, which combines the functions of the male connector of the blanket body and the main controller. This is also the key point of the present application.

In this embodiment, the male connector is provided with a built-in real-time temperature control main control circuit with an MCU, which mainly consists of a low-voltage DC power supply circuit, an MCU main control circuit, a temperature control sampling circuit, a temperature control driving circuit, a temperature control protection circuit, a user control information acquisition circuit, a temperature control state information display circuit, etc. It is used to implement a complete real-time temperature control function, and integrates user control information acquisition, temperature control state information acquisition and temperature control state information display (including heating level information, timing information, fault information, etc.).

Female connector of blanket body: referring to FIG. 3, ③ represents a female connector of the blanket body, which mainly plays a role of connecting the main controller with a heating wire.

Heating wire: referring to FIG. 3, ④ represents a heating wire of the product, which is mainly responsible for converting electric energy into heat energy so that the blanket body outputs heat to the outside.

Heating blanket body: referring to FIG. 3, ⑤ represents a body part of the product, which is formed by a multilayer flexible fabric closely sewn according to certain rules.

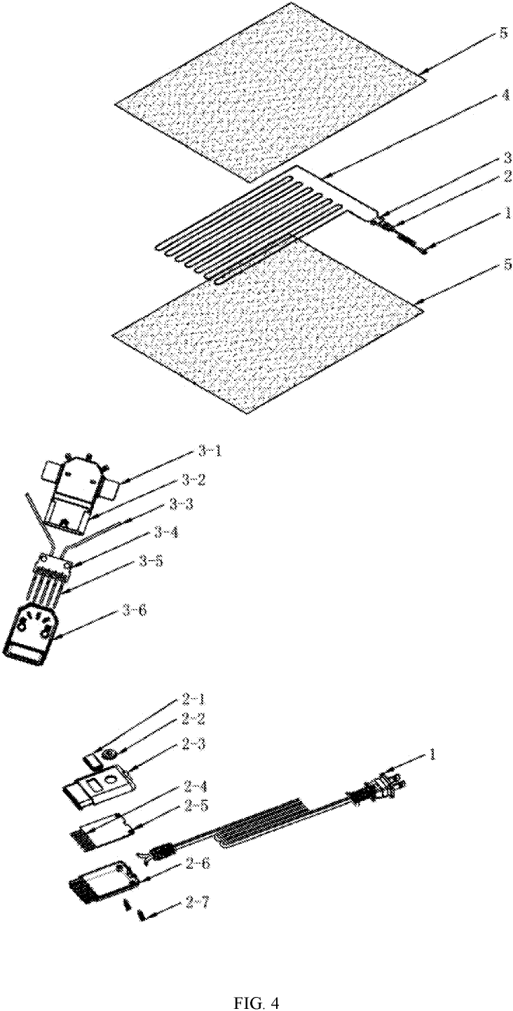

Referring to FIG. 4, in this embodiment, the product consists of a controller and a blanket body. The controller consists of a power line and a plug 1 for connecting the power grid. The power line is directly connected with the main controller 2.

In this embodiment, the main controller consists of a display window 2-1, a controller key 2-2, a controller upper cover 2-3, a female terminal 2-4, a PCB 2-5, a main controller lower cover 2-6, and fixing screws or fasteners 2-7.

In this embodiment, the blanket body consists of a connecting base 3 fixed on the blanket body, a heating wire 4 configured to heat, and a two-layer or multilayer fabric 5 configured to fix and cover the heating wire.

In this embodiment, the connecting base 3 includes a connector fixing piece 3-1 (soft plastic facilitating sewing the connecting base on the blanket body), a connector upper cover 3-2, a connecting line sheath 3-3 configured to protect the heating wire, a connector PCB 3-4, a male terminal 3-5 fixed on the connector PCB, and a connector lower cover 3-6.

In the specific implementation of this embodiment, the fabric 5 fixes the heating wire 4 according to a certain shape, and two ends of the heating wire 4 pass through the connecting line sheath 3-3 and are connected to the PCB 3-4 of the female connector 3 of the blanket body through a welding process; the male terminal 3-5 is welded on the PCB 3-4 and configured to realize electric connection with the female terminal of the main controller 2-2; the PCB 3-4 and the connector fixing piece 3-1 are clamped between the connector upper cover 3-2 and the connector lower cover 3-6, and then sewn on the blanket body through the connector fixing piece 3-1 to form the electric heating blanket body.

In this embodiment, the blanket body is connected to the main controller 2 through the female connector 3 of the blanket body, and the male terminal 3-5 completes the electrical connection with the female terminal 2-2; the female terminal 2-2 and the power line 1 are welded on the main controller PCB 2-3, and the main controller PCB 2-3 is fixed inside the controller upper cover 2-1 and the controller lower cover 2-4 through screws or pins 2-5.

The working mode of this embodiment is that the working state of the blanket body is set by operating the key on the controller. The display area 2-1 can display the setting state and working state of the product in real time.

The embodiments provide two structural forms of the electric heating tippet or electric heating covering blanket. One is that the male connector is used as a simple main controller, which is provided with a built-in control circuit with an MCU and in which an LED indication device may be selectively configured for indication, the man-machine dialoguing function is realized by sewing a silica gel panel on a convenient-to-operate side of the electric heating tippet or electric heating covering blanket, the built-in control circuit with the MCU is used as an auxiliary controller, power supply and communication transmission between the main controller and the auxiliary controller are realized through a two-core electronic wire, the heating wire of the blanket body is connected to the main controller, the main controller implements complete real-time temperature control, the auxiliary controller collects user control instructions and transmits them to the main controller for temperature control reference, and the main controller collects the heating control state and transmits the state back to the auxiliary controller for state display.

The other is that the male connector is used as a complete and independent controller, which is provided with a built-in control circuit with an MCU and in which man-machine dialogue channels (such as keys and LED display) are configured, the heating wire of the blanket body is connected to the main controller, the main controller independently completes the functions of user instruction collection, real-time temperature control, heating control state, state display and so on.

To sum up, the present application discloses a novel electric heating tippet or electric heating covering blanket that has not appeared in the industry before. The electric heating tippet or electric heating covering blanket realizes the miniaturization of the control circuit, and integrates the control circuit on the male connector connected with the blanket body. Therefore, the electric heating tippet or electric heating covering blanket only needs one power line for connection with the mains supply, and completely realizes real-time temperature control. Thus, on the one hand, a set of cumbersome controller and blanket body connecting line externally attached to the existing electric tippet or electric blanket is omitted. On the other hand, the product cost is greatly reduced.

What is claimed is:

1. A novel electric heating covering device, wherein the novel electric heating covering device comprises:
a main controller integrated in a male connector and configured to realize real-time temperature control, collect temperature control state information in real time, and transmit the temperature control state information to an auxiliary controller of a product through a data communication circuit;
the auxiliary controller provided with a built-in control circuit with an MCU and configured to acquire user control information, transmit the user control information to the main controller, and simultaneously display the temperature control state information transmitted from the main controller;
an auxiliary control power supply and communication line configured to connect the main controller and the auxiliary controller, the main controller supplying power to the auxiliary controller through the auxiliary control power supply and communication line to realize two-way communication;
a heating body provided with a heating wire and configured to convert electric energy into heat energy, a multilayer flexible fabric being closely sewn outside the heating wire.

2. The novel electric heating covering device according to claim 1, wherein the male connector is provided with a built-in real-time temperature control main control circuit with an MCU.

3. The novel electric heating covering device according to claim 2, wherein the real-time temperature control main control circuit with the MCU comprises a low-voltage DC power supply circuit, an MCU main control circuit, a temperature control sampling circuit, a temperature control driving circuit, a temperature control protection circuit, a data communication circuit, and an information indication circuit.

4. The novel electric heating covering device according to claim 1, wherein the main controller, the auxiliary controller and the heating wire are all connected with a female connector.

5. The novel electric heating covering device according to claim 1, wherein the control circuit with the MCU comprises a low-voltage DC conversion circuit, an MCU auxiliary control circuit, a data communication circuit, a control information acquisition circuit, and a state display circuit.

6. The novel electric heating covering device according to claim 1, wherein the heating body comprises a heating wire, which is uniformly and densely sewn in the middle of a non-woven fabric by a sewing thread.

7. The novel electric heating covering device according to claim 1, wherein the main controller comprises a main controller upper cover, a main controller lower cover, a connecting terminal welded on a main controller PCB, the main controller PCB, and a fixing screw or fastener.

8. The novel electric heating covering device according to claim 1, wherein the novel electric heating covering device further comprises a blanket body, and the blanket body consists of a connecting base fixed on the blanket body, an auxiliary control power supply communication line, an auxiliary controller configured to realize man-machine dialoguing, a heating wire configured to heat, and a two-layer or multilayer fabric configured to fix and cover the heating wire.

9. The novel electric heating covering device according to claim 8, wherein the connecting base comprises a connector fixing piece, a connector upper cover, a connecting line sheath configured to protect the heating wire, a connector PCB, a male terminal fixed on the connector PCB, and a connector lower cover.
